(19) United States
(12) Patent Application Publication
(10) Pub. No.: US 2017/0058521 A1
(43) Pub. Date: Mar. 2, 2017

(54) Wooden Lattice Ventilation Screen

(71) Applicant: Jon Timothy Olomon, Garden City, KS (US)

(72) Inventor: Jon Timothy Olomon, Garden City, KS (US)

(21) Appl. No.: 15/286,809

(22) Filed: Oct. 6, 2016

Related U.S. Application Data
(63) Continuation of application No. 62/283,179, filed on Aug. 24, 2015.

(51) Int. Cl. E04C 2/42; E06B 9/52; E04B 2/00

(52) U.S. Cl. CPC E04C 2/42; E04C 2/46; E06B 9/52

(57) ABSTRACT

This invention is designed as a rigid, stationary, non load bearing, exterior wall panel for installation in semi enclosed rooms, additions and outdoor structures such as decks, patios, gazebos, hot tub or spa enclosures, outdoor kitchens and dining areas, and as skirting for the enclosure of spaces beneath elevated constructs such as certain foundations, mobile homes, crawl spaces, porches, stairs, and walkways.

It is an improvement upon conventional wooden lattice panel in that in addition to ventilation, privacy, and prevention of entry by unauthorized persons, the incorporation of wire mesh insect screen prevents entry by flying insects, birds and other animals, blowing leaves and other debris, as well as reduce the quantity of snow and dust blown into said enclosure by wind.

The wooden latticework grid structure secures the screen layered within preventing it from becoming loose or sagging over time, a problem wherefor conventional insect screen is notorious.

Additionally, the segmented connecting lath strips which abutt the long strips of same which complete the gridwork structure and border the edges of said panel provide increased strength, durability, rigidity, structural integrity, and enhanced aesthetics.

### DESCRIPTION OF DRAWINGS

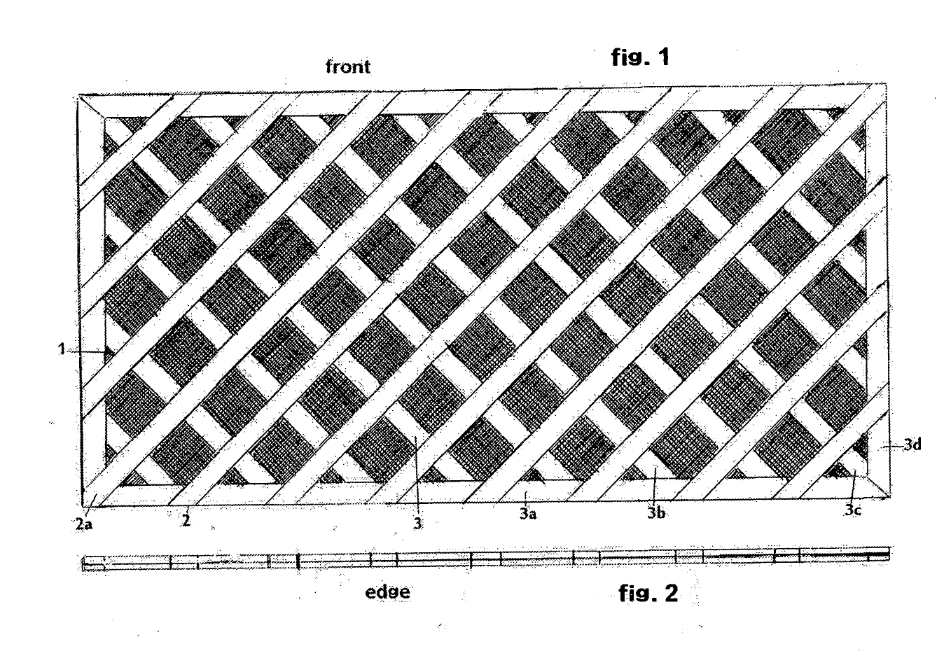

Page 1, FIGS. 1. and 2. illustrate an embodiment of said panel as viewed from the front and edge respectively.

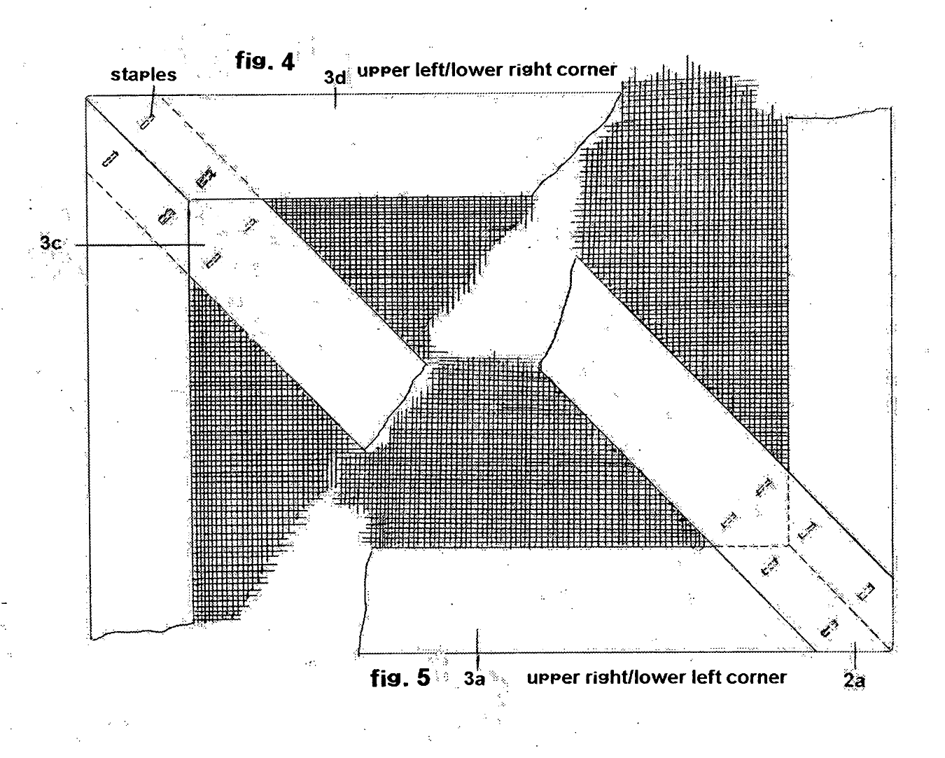

Page 2., FIG. 3. is a close up, detailed view of the convergence of the wooden lath strips which comprise the joints along the edges of said panel and the manner of construction thereof.

Page 3., FIGS. 4. and 5. are detailed illustrations of the upper left/lower right and upper right/lower left corners respectively as viewed from the front of said panel, depicting a more detailed view of the configuration of the aforementioned lath material and manner of construction thereof.

### DESCRIPTION

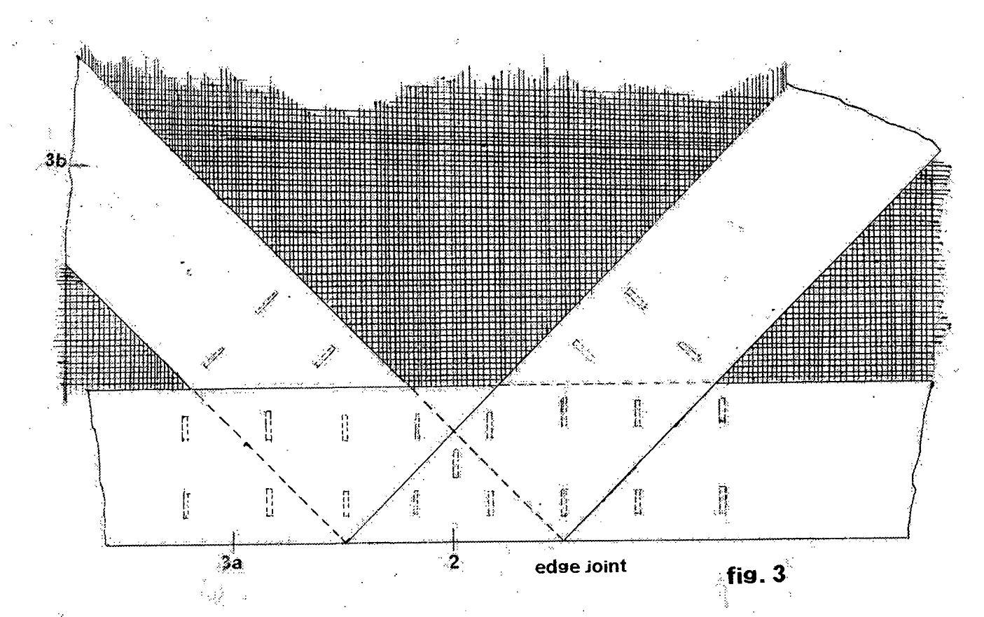

The invention described herein is a panel consisting of a wire mesh insect screen (page 1., FIG. 1., item 1.) layered between two sub panels (page 1., FIG. 2.), each consisting of long strips of wooden lath arranged along a plane in parallel (page 1., FIG. 1.) on the corresponding sub panel and perpendicular to same of opposite sub panel, and on a spacing evenly divisible into the dimensions (length and width) thereof.

The aforementioned wooden lath strips are abutted laterally along said plane and spacing by short connecting segments of same (page 1., FIG. 1., items 3., 3b., and 3c.) forming a complete grid across said sub panel and a border along the edges (pages 1. and 2., FIGS. 1. and 3., item 3a.) and corners (pages 1. and 3., FIGS. 1., 4., and 5., items 2a., 3a., and 3d.) thereof.

Each long strip and connecting segment of said wooden lath material is then fastened via staples, wood screws, or other fastening device to that of the opposite sub panel with which it aligns, intersects, overlaps, or interlocks (pages 2., and 3., FIGS. 3., 4., and 5.).

Whereas the embodiment shown in the accompanying drawings is substantially rectangular with apertures of a diamond configuration, others may be square or said apertures may be square, rectangular, or of other geometric configurations.

I claim the following:

1. The incorporation of wire mesh insect screen into a stationary, non load bearing wooden lattice panel

2. The utilization of the wooden grid structure described herein to secure said screen mentioned in claim 1.

3. The utilization of short segments of wooden lath material to form said grid structure and for further reinforcement and aesthetic enhancement.

4. The configuration and layout of the aforementioned long and short segmented wooden lath strips which comprise the joints along the edges and corners of said panel and the manner in which they are constructed wherein they overlap, intersect, and interlock.
